(19) United States
(12) Patent Application Publication
(10) Pub. No.: US 2008/0179860 A1
(43) Pub. Date: Jul. 31, 2008

(54) Automatic Tow Switch

(75) Inventor: Oliver A. Bell, Aiken, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/669,462

(22) Filed: Jan. 31, 2007

(51) Int. Cl. B60D 1/00

(52) U.S. Cl. 280/292

(57) ABSTRACT

A system for towing a light-weight utility vehicle is provided. The system includes a tow arm connectable to a distal portion of a towing vehicle. The system additionally includes a tow mode mechanism connectable to a distal portion of a towed vehicle and connectable with the tow arm. The tow mode mechanism automatically places the towed vehicle in a tow mode when the towing vehicle begins to tow the towed vehicle.

### FIELD

The present teachings relate to a towing system for light-weight utility vehicles.

### BACKGROUND

The statements in this section merely provide background information related to the present disclosure and may not constitute prior art.

On various occasions light-weight utility vehicles, such as maintenance vehicles, shuttle vehicles and golf cars, need to be towed from one location to another. For example, if a vehicle has operational problems or runs out of fuel, e.g., electrical, gaseous or liquid, and can not be driven to a maintenance location, or if two or more vehicles need to be transported using a single driver, towing of the one or more vehicles may be necessitated.

Typically, when towing a vehicle is desired, the vehicle to be towed (the towed vehicle) is manually placed in a tow mode, whereby the vehicle is configured to ‘free wheel’. That is, the motor and brakes of the towed vehicle are configured to allow the towed vehicle to substantially roll freely without encumbrance or resistance. More particularly, a manual operation such as lifting a seat of the vehicle to manually moving a lever or activating a switch is typically required to put the towed vehicle in the tow mode. Additionally, once the towed vehicle is placed in the tow mode, the towed vehicle remains in the tow mode until it is manually returned to a deceleration mode, e.g., lifting the seat to move the lever or deactivate the switch or manually depress the brake pedal, as in some golf cars, the brake is still active when in tow mode. Accordingly, when one or more vehicles are being towed by a vehicle (the towing vehicle) and the towing vehicle slows down or begins to come to a stop, since the towed vehicle(s) are free wheeling, the towed vehicle(s) will exert a large amount of force on the braking system of the towing vehicle. Such force can case damage to the towing car and be hazardous to the person driving the towing vehicle.

### SUMMARY

In various embodiments, a system for towing a light-weight utility vehicle is provided. The system includes a tow arm connectable to a distal portion of a towing vehicle. The system additionally includes a tow mode mechanism connectable to a distal portion of a towed vehicle and connectable with the tow arm. The tow mode mechanism automatically places the towed vehicle in a tow mode, e.g., a ‘free wheel’ mode, when the towing vehicle begins to tow the towed vehicle.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of the light-weight utility vehicle including a towing system for towing the vehicle, in accordance with various embodiments of the present disclosure;

FIG. 2 is an isometric rear view of a tow arm, shown in FIG. 1, removably connected to a towing vehicle, in accordance with various embodiments of the present disclosure;

FIG. 2a is an isometric rear view of a tow arm, shown in FIG. 1, removably connected to a towing vehicle, in accordance with various other embodiments of the present disclosure;

FIG. 3A is side view of a tow mode mechanism, shown in FIG. 1, in a tow mode position, in accordance with various embodiments of the present disclosure;

FIG. 3B is a top view of the tow mode mechanism shown in FIG. 3A, in a deceleration mode position;

FIG. 4A is side view of the tow mode mechanism, shown in FIG. 1, in a tow mode position, in accordance with various other embodiments of the present disclosure;

FIG. 4B is a top view of the tow mode mechanism shown in FIG. 4A, in a deceleration mode position;

FIG. 5 is an isometric view of the towing system, shown in FIG. 1, in accordance with various embodiments of the present disclosure;

FIG. 6 is an isometric rear view of a tow arm, shown in FIG. 1, removably connected to a towing vehicle, in accordance with various embodiments of the present disclosure; and

FIG. 7 is a top view of the tow mode mechanism, shown in FIG. 1, in accordance with various embodiments of the present disclosure.

### DETAILED DESCRIPTION

The following description is merely exemplary in nature and is in no way intended to limit the present teachings, application, or uses. Throughout this specification, like reference numerals will be used to refer to like elements.

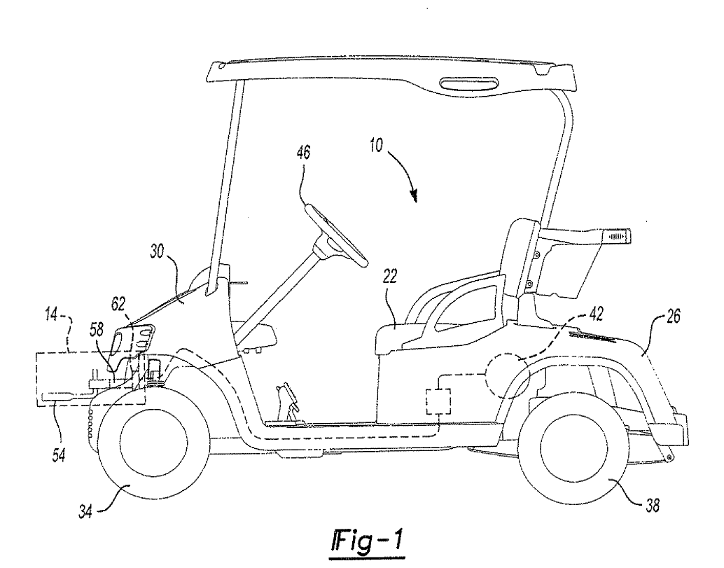

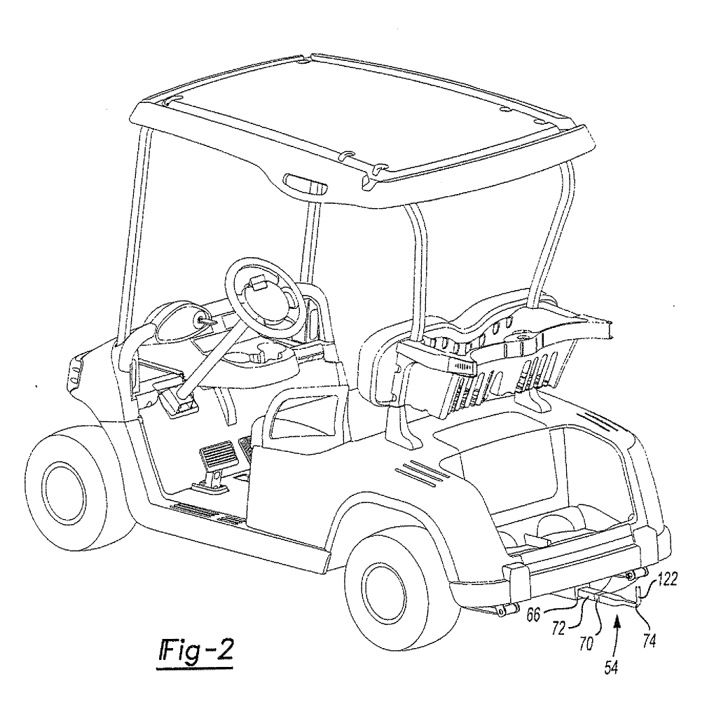

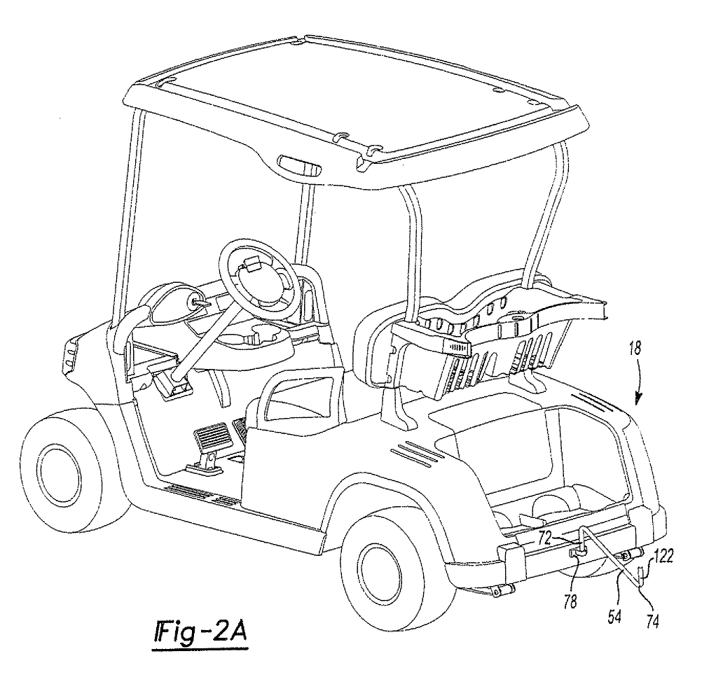

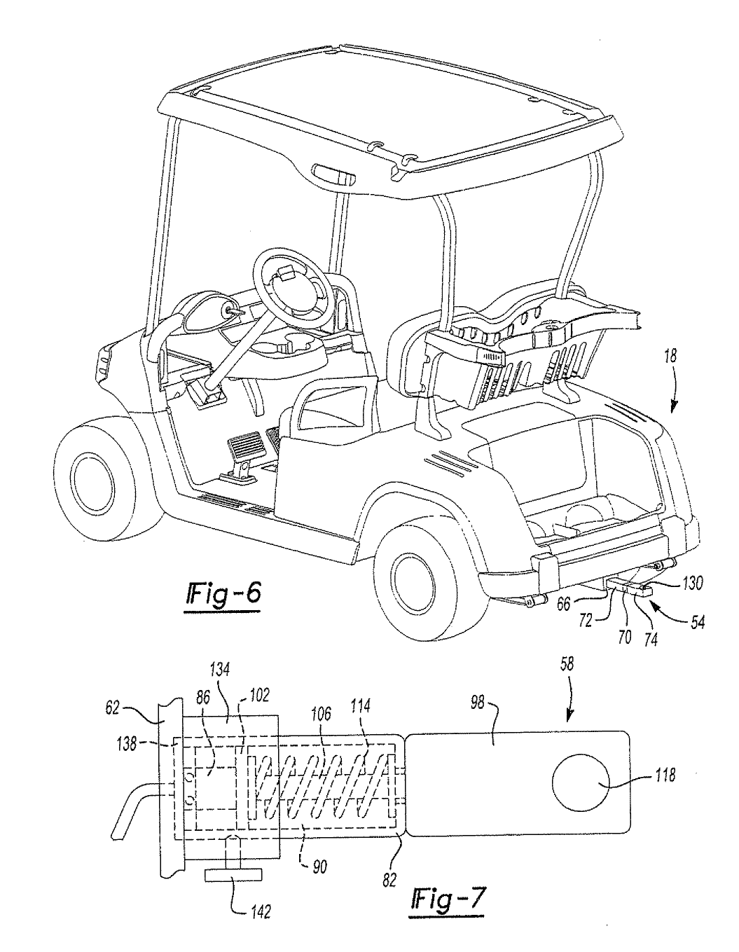

FIG. 1 illustrates a light-weight utility vehicle 10, such as a small cargo/maintenance vehicle, a shuttle vehicle or a golf car, that can comprise a towing system 14. The towing system 14 can be utilized to tow one or more vehicles 10 from a first location to a second location utilizing a towing vehicle 18, shown in FIGS. 2, 2A and 6, such as another vehicle 10, a tractor or any other vehicle suitable for towing one or more vehicles 10. Although the towing vehicle 18 is illustrated throughout the present disclosure as another vehicle 10, the scope of the disclosure should not be so limited. If more than one vehicle 10 is to be towed by the towing vehicle 18, the multiple vehicles 10 would be serially connected in a line using the towing system 14 to connect each vehicle 10 with the preceding vehicle 10.

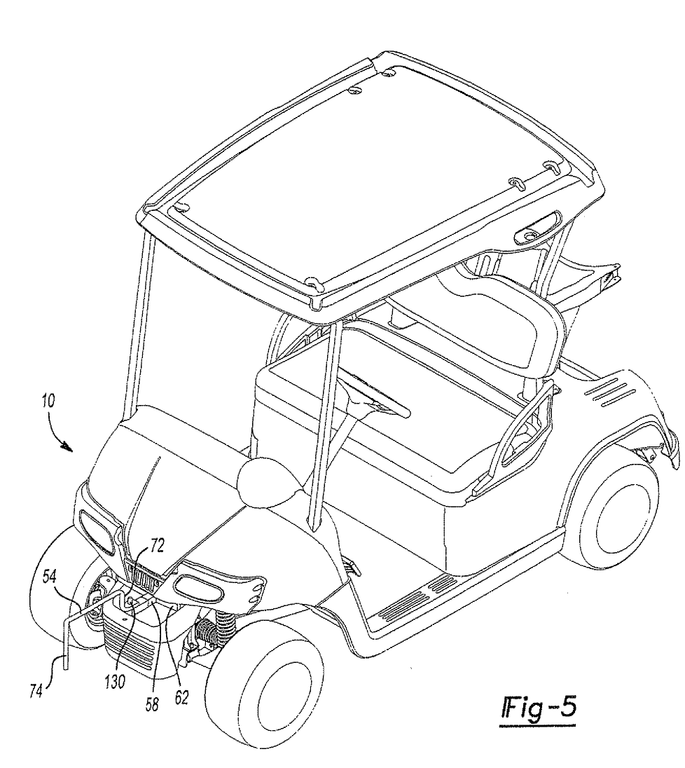

The vehicle 10 also generally can comprise a seat assembly 22 mounted to a rear body section 26, a front body section 30 and a pair of front wheels 34 that operate to steer the vehicle 10. Additionally, the vehicle 10 can comprise a pair of rear wheels 38, wherein at least one of the rear wheels 38 is driven by a prime mover 42, e.g., an AC induction motor or other electric motor, for propelling vehicle 10. The vehicle 10 can further include a steering wheel 46 used to control a steering angle of the front wheels 34 and a main controller 50 for controlling various operations of the vehicle 10. For example, the controller 50 can be communicatively connected to the prime mover 42 to send operational commands to the prime mover 42 to dictate movement of the vehicle 10. In various embodiments, as described below, the towing system 14 is communicatively connected to the controller 50 to switch the vehicle 10 between a deceleration mode and a tow mode. Generally, the towing system 14 includes a tow arm 54 and a tow mode mechanism 58. The tow arm 54 is removably connectable to the tow mode mechanism 58 and the towing car 18, as exemplarily illustrated in FIGS. 1 and 5. The tow mode mechanism 58 is connected to vehicle 10 in either an affixed manner or removably connectable manner, as further described below. For example, in various embodiments, the tow mode mechanism 58 is connected to a brace structure 62 mounted to the vehicle 10, for example, mounted to a frame structure (not shown) of the vehicle 10.

Referring now to FIG. 2, the tow arm 54 is removably connectable to the towing vehicle 18 in any suitable manner. For example, as exemplarily illustrated in FIG. 2, a lead end 72 of the tow arm 54 can be removably matable with a hitch tube 66. In which case, the tow arm 54 would be inserted and locked into the hitch tube 66 and include a universal joint 70 to allow a trailing end 74 of the tow arm 54 to move relative to the motion of the vehicle 10 being towed. However, the scope of the present disclosure should not be limited the exemplary embodiment shown in FIG. 2. The tow arm 54 can be removably connectable to the towing vehicle 18 in any suitable manner and can have any shape suitable to correspond to the various manners of removable connecting the tow arm 54 to the towing vehicle 18. For example, as exemplarily illustrated in FIG. 2A, the tow arm 54 can generally have an ‘S’ or ‘Z’ shape such that the lead end 72 of the tow bar 54 is insertable into a retainer bracket 78 mounted to towing vehicle 18 and the opposing trailing end 74 of the tow bar 54 can be removably connectable with the tow mode mechanism 58 in any suitable manner as describe below. As a further example, the tow bar 54 can generally have a ‘C’ or ‘U’ shape as effectively illustrated in FIG. 5.

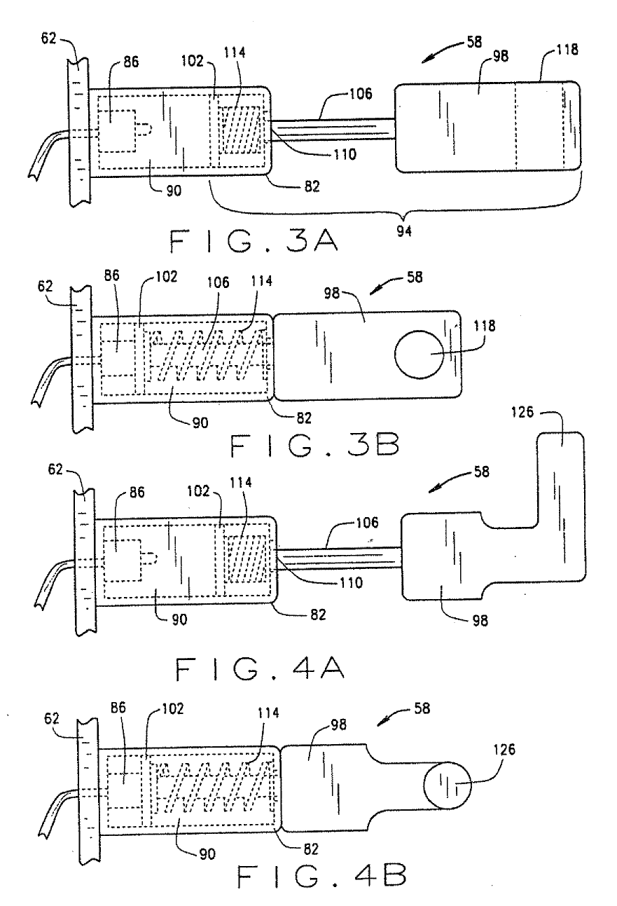

Referring now to FIGS. 3A and 3B, in various embodiments, the tow mode mechanism 58 includes a piston housing 82 including a mode switch 86 mounted within an interior cavity 90 of the piston housing 82. The mode switch 86 is incorporated to transition an operational status of the vehicle 10 between a tow mode and a deceleration mode. For example, in various embodiments, the mode switch 86 is communicatively connected to the main controller 50 to command the controller 50 to transition an operational status of the vehicle 10 between a tow mode and a deceleration mode.

When the mode switch 86 is placed in a tow position, as shown in FIG. 3A, the vehicle 10 is placed in a tow mode, i.e., a ‘freewheel’ mode, in which the prime mover 42 and any braking system (not shown) of the vehicle 10 are disengaged to allow the wheels 34 and 38 to rotate freely, without resistance. For example, when the mode switch 86 is placed in the tow position, the mode switch 86 commands the controller 50 to disengage the prime mover 42 and any brake system to allow the wheels 34 and 38 to ‘freewheel’ as the towing vehicle 18 begins to tow the vehicle 10. When the mode switch 86 is placed in a deceleration position, as shown in FIG. 3B, the vehicle 10 is placed in a deceleration mode, in which the wheels 34 and/or 38 are inhibited from ‘freewheel’ movement. For example, when the mode switch 86 is placed in the deceleration position, the mode switch 86 commands the controller 50 to engage the prime mover 42 while leaving any brake system disengaged, thereby inhibiting rotation of the wheels 34 and/or 38 and movement of the vehicle 10. It should be understood that when the vehicle 10 is placed in the deceleration mode, via the tow mode mechanism 58, the vehicle can further be placed in a drive mode by other vehicle mechanisms, e.g., place a start switch in an ‘On’ position, whereby the vehicle 10 can be driven normally as a self-propelled vehicle. Therefore, the tow mode mechanism 58 can be effectively permanently affixed to the vehicle 10, whereby the vehicle 10 can be operated and function normally until the vehicle 10 needs to be towed. At which point, normal operation of the vehicle 10 will be disabled. pplacing the start switch to an ‘ON’ position, will permit towing system 14 to control switching the vehicle 10 in the tow mode and the deceleration mode, as described herein.

To operate the mode switch 86, in various embodiments, the tow mode mechanism 58 includes a biased piston 94. The piston 94 includes a piston head 98 connected to a piston foot 102 via a piston shaft 106. The piston foot 102 is movable within the housing cavity 90. More particularly, piston foot 102 is linearly movable within housing cavity 90 to operate the mode switch 86 and thereby switch the operational status of the vehicle 10 between the tow mode and the deceleration mode. Even more particularly, the piston shaft 106 extends through an aperture 110 in the piston housing 82 such that the piston foot 102 is linearly movable within the housing cavity 90 via manipulation of the piston head 98. Accordingly, if the piston head 98 is pulled away from the piston housing 82, as illustrated in FIG. 3A, the piston foot 102 is linearly moved away from the mode switch 86 placing the mode switch 86 in the tow position, and thus, the vehicle 10 in the tow mode. Conversely, if the piston head 98 is biased or pushed toward the piston housing 82, as illustrated in FIG. 3B, the piston foot 102 is linearly moved toward, and potentially in contact, with the mode switch 86. If the piston head 98 is biased or pushed into contact with the piston housing 82, the piston foot 102 substantially simultaneously contacts the mode switch 86 placing the mode switch 86 in the deceleration position, and thus, the vehicle 10 in the deceleration mode.

As described above, the tow arm 54 is removably connectable between the towing vehicle 18 and the vehicle 10 to be towed. That is, the lead end 72 of the tow arm 54 is removably connectable to the towing vehicle 18 and the trailing end 74 is removably connectable to the piston head 98 of the tow mode mechanism 58. Therefore, when the towing vehicle 18 begins to move in order to tow the vehicle 10, the tow arm 54 pulls the piston head 98 away from the housing 82. As the piston head 98 moves away from the housing 82, the piston shaft 106 pulls the piston foot 102 away from, and out of contact with, the mode switch 86, thereby placing the vehicle 10 in the tow mode such that the wheels 34 and 38 turn freely to allow the towing vehicle 18 tow the vehicle 10. Once the vehicle 10 is being towed by the towing vehicle 18, when the towing vehicle 18 slows, starts to stop or travels down an incline, the weight and/or momentum of the vehicle 10 being towed will cause the vehicle 10 to move at a speed greater than the towing vehicle 18. In this case, the vehicle 10 will effectively try to begin to exert a pushing force on the towing vehicle 18. However, as the vehicle 10 moves forward at a greater speed than the towing vehicle 18 is moving forward, the tow arm 54 will push the piston head 98 toward the housing 82. This will cause the piston foot 102 to contact the mode switch 86 and place the mode switch in the deceleration position. Accordingly, the vehicle 10 will be placed in the deceleration mode such that the vehicle 10 is inhibited from continuing to move. If the towing vehicle 18 subsequently begins to tow the vehicle 10, the piston foot 102 will be moved out of contact with the mode switch 86 and the vehicle 10 will be returned to the tow mode.

In various embodiments, the tow mode mechanism 58 further includes a biasing device 114 for retracting the piston head 98 to bias the piston foot 102 into contact with the mode switch 86 and place the vehicle 10 in the deceleration mode. Particularly, the biasing device 114 will return the piston head 98 into contact with the housing 82 and the piston foot 102 into contact with the mode switch 86 when the towing vehicle 18 is not towing, or stops towing, the vehicle 10. Thus, when the vehicle 10 is not being towed or is being towed and the towing vehicle 18 slow, starts to stop or travels down an incline, the biasing device 114 will cause the piston foot to contact the mode switch 86 and place the vehicle 10 in the deceleration mode. The biasing device 114 can be any suitable biasing device such as a spring or a pneumatic or hydraulic cylinder.

Referring now to FIGS. 1, 2, 2A, 3A and 3B, the removable connection, i.e., coupling, between the trailing end 74 of the tow arm 54 and the piston head 98 of the tow mode mechanism can be embodied in any suitable manner and remain within the scope of the present disclosure. For example, the piston head 98 can include an aperture 118 suitable for receiving a coupling finger 122 of the tow arm trailing end 74. Thus, tension or compression on the tow arm 54 as the towing vehicle 18 tows the vehicle 10 will cause the piston head and foot 98 and 102 to be extended or retracted, as described above, to transition the vehicle 10 between the towing and deceleration modes.

Another exemplary embodiment of the coupling between the trailing end 74 of the tow arm 54, is illustrated in FIGS. 4A, 4B, 5 and 6. The piston head 98 can include a piston head finger 126 suitable for insertion into a coupling aperture 130 of the tow arm trailing end 74. Thus, tension or compression on the tow arm 54 as the towing vehicle 18 tows the vehicle 10 will cause the piston head and foot 98 and 102 to be extended or retracted, as described above, to transition the vehicle 10 between the towing and deceleration modes. Many other embodiments of the removable coupling between the trailing end 74 of the tow arm 54 and the piston head 98 are envisioned, such as a clevis pin and joint connection, a snap-lock type connection, a ball and cup hitch connection, etc.

Referring now to FIGS. 3A, 3B and 7, as described above, the tow mode mechanism 58 is connected to vehicle 10 in either an affixed manner or removably connectable manner. As illustrated in FIGS. 3A and 3B, in various embodiments, the tow mode mechanism 58 can be substantially permanently affixed to the vehicle 10, for example, substantially permanently affixed to the brace structure 62. As illustrated in FIG. 7, in various other embodiments, the tow mode mechanism 58 can be removably connectable with the vehicle 10, for example, removably connectable with the brace structure 62. The exemplary embodiment of FIG. 7 includes a receiving socket 134 substantially permanently affixed to the vehicle 10, for example, substantially permanently affixed to the brace structure 62. The receiving socket 134 includes a signal communication connector 138 adapted to mate with and communicatively couple with the mode switch 86. Thus, the tow mode mechanism 58 can be inserted into and removed from the receiving socket 134. When the tow mode mechanism is inserted into the receiving socket 134 the signal communication connector 138 communicatively couples the mode switch such that the mode switch can send tow mode signals and deceleration signals to transition the vehicle 10 between the tow mode and the deceleration mode, as described above. Additionally, the receiving socket can include a fastening or locking device 142, such as a thumb screw or retention pin, to firmly retain the tow mode mechanism 58 to the vehicle 10.

When the towing system 14 is incorporated to tow more than one vehicle 10, each vehicle 10 would be aligned head-to-toe using a separate towing system 14 to connect the first vehicle 10 to the towing vehicle 18 and each subsequent vehicle 10 to the preceding vehicle 10. Thus, as the towing vehicle 18 begins to tow the line of vehicles 10 the tow mode mechanism 58 connected to each vehicle 10 will automatically place the respective vehicle 10 in the tow mode. And, as the towing vehicle 18 tows the line of vehicles 10, the tow mode mechanisms 58 will automatically transition the respective vehicles 10 between the tow mode and the deceleration mode, as described above.

Therefore, the towing system 14, as described herein, provides a towing system for one or more light-weight utility vehicles 10 that automatically transitions the vehicle(s) 10 between the tow mode and the deceleration mode as the vehicle(s) 10 are being towed from a first location to a second location.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A system for towing a light-weight utility vehicle, said system comprising:
a tow arm connectable to a distal portion of a towing vehicle; and
a tow mode mechanism connectable to a distal portion of a towed vehicle and connectable with the tow arm, the tow mode mechanism configured to automatically place the towed vehicle in a tow mode when the towing vehicle begins to tow the towed vehicle.

2. The system of claim 1, wherein the tow mode mechanism is further adapted to automatically place the towed vehicle in a deceleration mode when the towing vehicle is not towing the towed vehicle.

3. The system of claim 1, wherein the tow mode mechanism comprises a piston housing including a mode switch mounted within an interior cavity of the piston housing, the mode switch configured to place the towed vehicle in the tow mode when in a tow mode position.

4. The system of claim 3, wherein the tow mode mechanism further comprises a biased piston comprising a piston head connected to a piston foot via a piston shaft, the piston foot within the piston housing and adapted to operate the mode switch, the piston shaft extending through an aperture in the piston housing such that the piston foot is movable within the piston housing via manipulation of the piston head.

5. The system of claim 4, wherein the piston head is connectable to the tow arm such that as the towing vehicle begins to tow the towed vehicle the piston is extended pulling the piston head away from the piston housing and the piston foot away from the mode switch to place the mode switch in the tow mode position.

6. The system of claim 4, wherein the tow mode mechanism further comprises a biasing device for retracting the piston to bias the piston foot in contact with the mode switch to place the mode switch in a deceleration mode position when the towed vehicle is not being towed, thereby placing the towed vehicle in a deceleration mode.

7. The system of claim 5, wherein the piston head is connectable to the tow arm such that as the towing vehicle begins to stop towing the towed vehicle, the piston head is pushed toward the piston housing contacting the piston foot with the mode switch to place the mode switch in a deceleration mode position, thereby placing the towed vehicle in a deceleration mode.

8. The system of claim 1, wherein the tow mode mechanism is configured to be affixed to a brace structure mounted to the car.

9. The system of claim 1, wherein the tow mode mechanism is configured to be removably connectable to a brace structure mounted to the car.

10. A light-weight utility vehicle comprising:
a towing system for adapting the vehicle to be towed by a towing vehicle, said system comprising:
a tow arm connectable to a distal portion of the towing vehicle; and
a tow mode mechanism connectable to a distal portion of the towed vehicle and connectable with the tow arm, the tow mode mechanism configured to automatically place the towed vehicle in a tow mode when the towing vehicle begins to tow the towed vehicle.

11. The vehicle of claim 10, wherein the tow mode mechanism is further adapted to automatically place the towed vehicle in a deceleration mode when the towing vehicle is not towing the towed vehicle.

12. The vehicle of claim 11, wherein the tow mode mechanism comprises a piston housing including a mode switch mounted within an interior cavity of the piston housing, the mode switch configured to place the towed vehicle in the tow mode when in a tow mode position.

13. The vehicle of claim 12, wherein the tow mode mechanism further comprises a biased piston comprising a piston head connected to a piston foot via a piston shaft, the piston foot within the piston housing and adapted to operate the mode switch, the piston shaft extending through an aperture in the piston housing such that the piston foot is movable within the piston housing via manipulation of the piston head.

14. The vehicle of claim 13, wherein the piston head is connectable to the tow arm such that as the towing vehicle begins to tow the towed vehicle the piston is extended pulling the piston head away from the piston housing and the piston foot away from the mode switch to place the mode switch in the tow mode position.

15. The vehicle of claim 13, wherein the tow mode mechanism further comprises a biasing device for retracting the piston to bias the piston foot in contact with the mode switch to place the mode switch in a deceleration mode position when the towed vehicle is not being towed, thereby placing the towed vehicle in a deceleration mode.

16. The vehicle of claim 14, wherein the piston head is connectable to the tow arm such that as the towing vehicle begins to stop towing the towed vehicle the piston head is pushed toward the piston housing contacting the piston foot with the mode switch to place the mode switch in a deceleration mode position, thereby placing the towed vehicle in a deceleration mode.

17. The vehicle of claim 10, wherein the tow mode mechanism is configured to be affixed to a brace structure mounted to the towed vehicle.

18. The vehicle of claim 10, wherein the tow mode mechanism is configured to be removably connectable to a brace structure mounted to the towed vehicle.

19. A system for towing a light-weight utility vehicle, said system comprising:
a tow arm connectable to a distal portion of a towing vehicle; and
a tow mode mechanism connectable to a distal portion of a towed vehicle and connectable with the tow arm, the tow mode mechanism configured to automatically place a motor of the towed vehicle in a tow mode when the towing vehicle begins to tow the towed vehicle and automatically place the motor of the towed vehicle in a deceleration mode when the towing vehicle is not towing the towed vehicle.

20. The system of claim 19, wherein the tow mode mechanism comprises a piston housing including a mode switch mounted within an interior cavity of the piston housing, the mode switch configured to place the towed vehicle in the tow mode when in a tow mode position.

21. The system of claim 20, wherein the tow mode mechanism further comprises a biased piston comprising a piston head connected to a piston foot via a piston shaft, the piston foot within the piston housing and adapted to operate the mode switch, the piston shaft extending through an aperture in the piston housing such that the piston foot is movable within the piston housing via manipulation of the piston head.

22. The system of claim 21, wherein the piston head is connectable to the tow arm such that as the towing vehicle begins to tow the towed vehicle the piston is extended pulling the piston head away from the piston housing and the piston foot away from the mode switch to place the mode switch in the tow mode position.

23. The system of claim 21, wherein the tow mode mechanism further comprises a biasing device configured to retract the piston biasing the piston foot in contact with the mode switch to place the mode switch in a deceleration mode position when the towed vehicle is not being towed, thereby placing the towed vehicle in a deceleration mode.

24. The system of claim 22, wherein the piston head is connectable to the tow arm such that as the towing vehicle begins to stop towing the towed vehicle the piston head is pushed toward the piston housing contacting the piston foot with the mode switch to place the mode switch in a deceleration mode position, thereby placing the towed vehicle in a deceleration mode.

25. The system of claim 19, wherein the tow mode mechanism is configured to be affixed to a brace structure mounted to the towed vehicle.

26. The system of claim 1 wherein the tow mode mechanism is configured to be removably connectable to a brace structure mounted to the towed vehicle.
